(19) United States
(12) Patent Application Publication
(10) Pub. No.: US 2014/0109487 A1
(43) Pub. Date: Apr. 24, 2014

(54) Height and Width Adjustment System for Sliding Doors

(71) Applicant: Marcel Daoust, Toronto (CA)

(72) Inventor: Marcel Daoust, Toronto (CA)

(21) Appl. No.: 13/963,963

(22) Filed: Aug. 9, 2013

(30) Foreign Application Priority Data
Sep. 12, 2012 (CA) 2785199

(51) Int. Cl. E06B 1/52; E06B 3/92

(52) U.S. Cl. CPC E06B 1/52; E06B 3/92
USPC 49/505

(57) ABSTRACT

A height and width adjustment system for a sliding door in a door frame having an interconnected header, sill, jamb rail and side jambs. An interlock rail and lock rail is secured to the jamb rail and side jambs, and top and bottom cross rails are secured to the interlock rail and lock rail. Adjustment shims are then inserted into any of the top and bottom cross rails, the interlock rail, the lock rail and the jamb rail whereby a height of the sliding door can be adjusted.

The present invention relates to a height and width adjustment system for a sliding door in a door frame. More particularly, the present invention relates to a height and width adjustment system for a sliding door in a door frame which utilizes adaptors which can be connected to the header frame, and adjustment shims which can be connected to the interlock rails, cross rails and lock rails to tailor the door height and width to specific requirements.

### BACKGROUND OF THE INVENTION

In the past, the adjustment of sliding door placement usually occurred on a minor scale, and involved minor adjustment of the tracks, or cleaning of the sliding rails and tracks. For example, a door lock will not meet up with the frame latch unless the rollers hold the door to the correct height, and if this height is not equal, adjustment may be required.

However, adjustment of sliding doors to accommodate various door frame dimensions is more problematic, and make them fit properly, as the adjustment dimension required may involve accommodation and movement of the door height or width of a half inch, and more, that simple adjustment of the track, or track cleaning, cannot provide for.

Furthermore, glass sizes in the sliding glass door industry can be basically account for half of the door material cost, and material lead times can to order such glass can be lengthy. Accordingly, having the ability to adjust the over-all door size, without necessarily having to change the glass size, would therefore would enable major cost saving and also avoid lengthy waiting glass ordering times.

It would therefore be advantageous to have a height and width adjustment system for a sliding door in a door frame.

It would be further advantageous to have a height and width adjustment system for a sliding door in a door frame which utilizes adaptors which can be connected to the header, sill and door jamb frames, and adjustment shims which can be connected to the interlock rails, cross rails and lock rails to tailor the door height and width to specific requirements. In this regard, the present invention substantially fulfills this need.

### SUMMARY OF THE INVENTION

It is an object of the present invention to provide an improved, height and width adjustment system for a sliding door in a door frame.

It is a further object of the present invention to provide an improved, height and width adjustment system for a sliding door in a door frame, and which utilizes adaptors which can be connected to the header, sill and door jamb frames, and adjustment shims which can be connected to the interlock rails, cross rails and lock rails to tailor the door height and width to specific requirements.

It is a further object of the present to provide an improved, height and width adjustment system for a sliding door in a door frame, which provides the ability to adjust the over-all door size, without necessarily having to change the glass size, so as to enable major cost savings and also avoid lengthy waiting glass ordering times.

According to one aspect of the present invention, there is provided a height and width adjustment system for a sliding door in a door frame having an interconnected header, sill, jamb rail and side jambs, comprising an interlock rail and lock rail secured to the jamb rail and side jambs; top and bottom cross rails secured to the interlock rail and lock rail; and adjustment shims constructed and arranged for insertion into any of the top and bottom cross rails, the interlock rail, the lock rail and the jamb rail whereby a height of the sliding door can be adjusted.

According to another aspect of the present invention, there is provided a height and width adjustment system for a sliding door in a door frame having an interconnected header, sill, jamb rail and side jambs, comprising an interlock rail and lock rail secured to the jamb rail and side jambs; top and bottom cross rails secured to the interlock rail and lock rail; adjustment shims constructed and arranged for insertion into any of the top and bottom cross rails, the interlock rail, the lock rail and the jamb rail whereby a height of the sliding door can be adjusted; and an adaptor which can be connected to the header to adjust the height of the sliding door.

### BRIEF DESCRIPTION OF THE DRAWINGS

The embodiments of the present invention will now be described by reference to the following figures, in which identical reference numerals in different figures indicate identical elements and in which:

FIG. 1 is an overview of an embodiment of the height and width adjustment system for a sliding door of the present invention;

FIG. 2A is a side perspective view of an embodiment of an adjustment shim for the height and width adjustment system of the present invention, connected to the interlock rail, shown utilizing one shim;

FIG. 2B is a side perspective view of an embodiment of adjustment shims connected to the lock rail, shown utilizing four shims;

FIG. 2C is a side perspective view of an embodiment of the adjustment shims connected to the cross rails, shown utilizing four shims; and

FIG. 3 is a top view of an embodiment of an adaptor for the height and width adjustment system of the present invention which can be connected to the header, sill and door jamb frames.

### DETAILED DESCRIPTION OF THE INVENTION

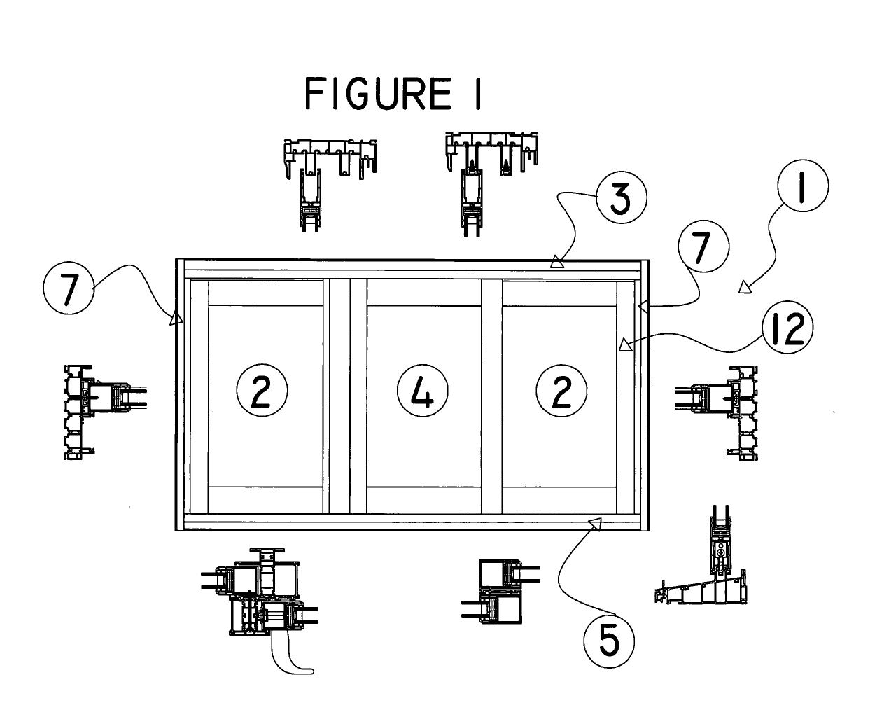

In terms of describing the individual components of the system in greater detail, and with reference to FIGS. 1 to 3, the improved, height and width adjustment system of the present invention is designated in its entirety in FIG. 1 by the reference numeral 1.

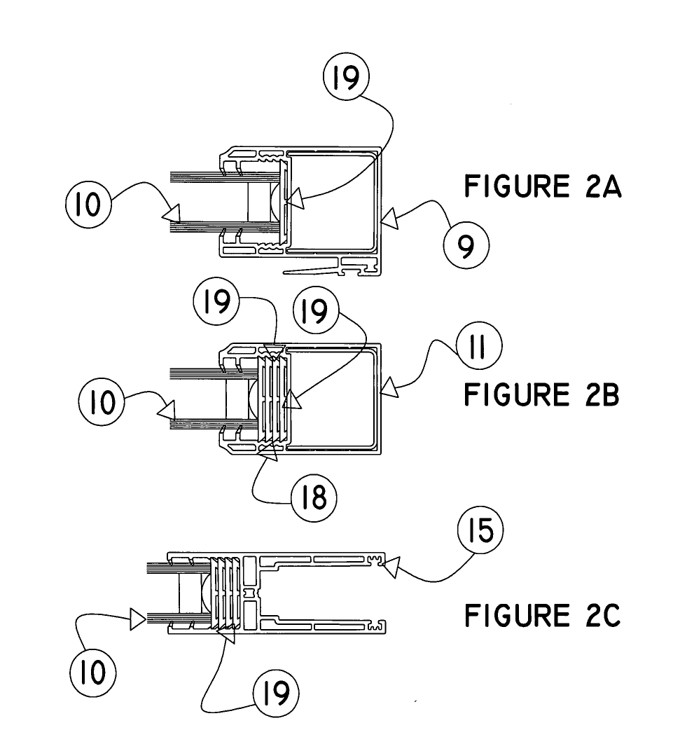

Referring to FIG. 1, a first exemplary embodiment of the height and width adjustment system of the present invention is shown. As is known in the art, sliding patio door assemblies comprise a header 3 at the top portion of the door frame which is secured to side jambs 7. Similarly, a sill 5 at the bottom of the door frame is also secured to side jambs 7. In each instance, these are typically fastened or secured through conventional means such as screws (not shown). With further reference to FIGS. 2A, 2B and 2C, an interlock rail 9 and a lock rail 11 are then secured to the side jambs 7, and, top and bottom cross rails 15 are then secured to the interlock rail 9 and lock rail 11 for an operating (slidable) door 4. In the case of a fixed door 2, an interlock rail 9 and a jamb rail 12 (shown in FIG. 1) are secured to the top and bottom cross rails 15.

In adjusting the height and/or width of the sliding door, adjustment shims 19 can be inserted into any of the top and bottom cross rails 15, interlock rail 9, lock rail 11 and the jamb rail 12, as a means to adjust a height or width of the panel 10 within the door (2,4), and thus also the door height and width. Though FIGS. 2A, 2B and 2C illustrate the number of adjustment shims 19 being utilized as between one and four, a worker skilled in the art would understand that this number could be varied as necessary. In an exemplary embodiment, these adjustment shims 19 would be made of plastic or rubber or other materials known to workers skilled in the art, and are inserted as fillers to reside between the panel 10, the top and bottom cross rails 15, interlock rail 9, lock rail 11 and the jamb rail 12. Alternatively, the adjustment shims 19, as shown in FIG. 2B, can also be positioned within grooves or notches 18 located on an interior surface of the top and bottom cross rails 15, interlock rail 9, lock rail 11 and the jamb rail 12. Alternatively, it will be readily understood that such attachment of the adjustable shims 19 could likewise be also attained through conventional means, such as adhesive or screws, and that the adjustment shims 19 could be made of varying thicknesses, as required.

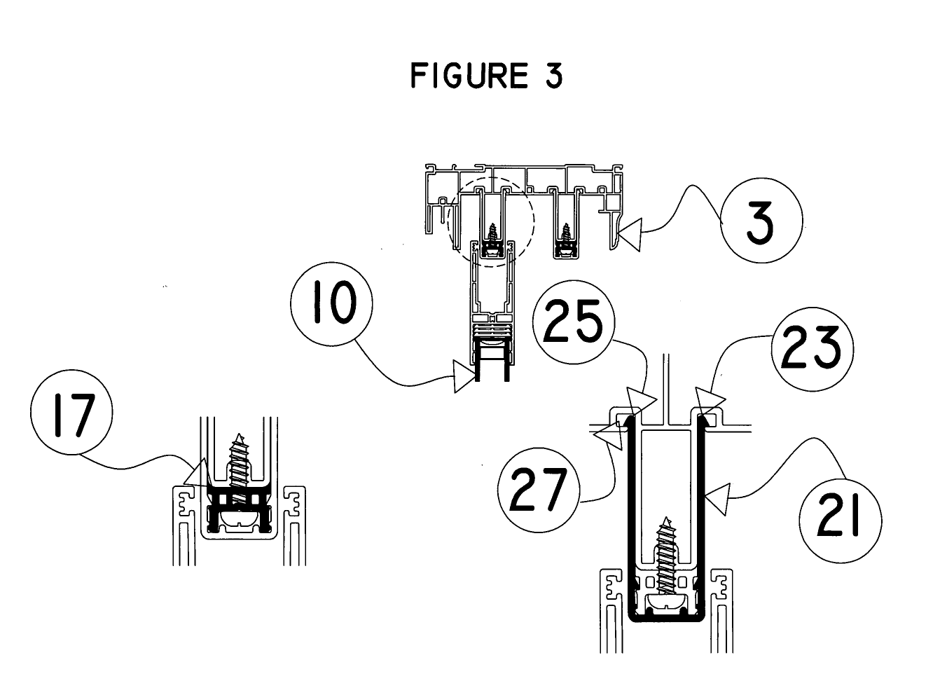

With reference to FIG. 3, there is shown as exemplary embodiment of the adaptor 17 which can be connected to the header 3 of a sliding door frame assembly, as a means to adjust a height of the door (2,4). In an exemplary embodiment, the adaptor 17 is secured to the header 3 by means of screws. In a further exemplary embodiment, the adaptor 17 further comprises an adaptor cover 21, which has elongated ends 23, 25, which can be inserted into a recessed area 27 on the header 3. Alternatively, it will be readily understood that such attachment of the adaptor 17 could likewise be also attained through other conventional means, such as adhesive.

Of course, it will also be readily understood that the adjustment shims 19 and the adaptor 17 can be used in conjunction with one another, as shown in FIG. 3, so as to more readily tailor both the door's height and width to specific requirements.

Other embodiments consistent with the present invention will become apparent from consideration of the specification and the practice of the invention disclosed therein.

Accordingly, the specification and the embodiments are to be considered exemplary only, with the true scope and spirit of the invention being disclosed by the following claims.

The embodiments of the invention in which an exclusive property or privilege is claimed are defined as follows:

1. A height and width adjustment system for a sliding door in a door frame having an interconnected header, sill, jamb rail and side jambs, comprising:
an interlock rail and lock rail secured to the jamb rail and side jambs;
top and bottom cross rails secured to the interlock rail and lock rail; and
adjustment shims constructed and arranged for insertion into any of the top and bottom cross rails, the interlock rail, the lock rail and the jamb rail whereby a height of the sliding door can be adjusted.

2. The height and width adjustment system according to claim 1, wherein the adjustment shims are constructed of plastic or rubber.

3. The height and width adjustment system according to claim 1, further comprising an adaptor which can be connected to the header to adjust the height of the sliding door.

4. The height and width adjustment system according to claim 1, wherein the interlock rail, the lock rail, the jamb rail and the top and bottom cross rails have notches formed on an interior surface thereof constructed and arranged to retain the adjustment shims therein.

5. A height and width adjustment system for a sliding door in a door frame having an interconnected header, sill, jamb rail and side jambs, comprising:
an interlock rail and lock rail secured to the jamb rail and side jambs;
top and bottom cross rails secured to the interlock rail and lock rail;
adjustment shims constructed and arranged for insertion into any of the top and bottom cross rails, the interlock rail, the lock rail and the jamb rail whereby a height of the sliding door can be adjusted; and
an adaptor which can be connected to the header to adjust the height of the sliding door.

6. The height and width adjustment system according to claim 5, wherein the interlock rail, the lock rail, the jamb rail and the top and bottom cross rails have notches formed on an interior surface thereof constructed and arranged to retain the adjustment shims therein.
